(19) United States
(12) Patent Application Publication
(10) Pub. No.: US 2015/0354652 A1
(43) Pub. Date: Dec. 10, 2015

(54) BRAKE SENSOR

(71) Applicant: RIMTEC PTY LTD, South Brisbane, Queensland (AU)

(72) Inventors: Darren Wong, South Brisbane (AU); Trevor Mariner, South Brisbane (AU)

(21) Appl. No.: 14/759,616

(22) PCT Filed: Jan. 10, 2014
(86) PCT No.: PCT/AU2014/000016

§ 371 Date: Jul. 7, 2015

(30) Foreign Application Priority Data
Jan. 10, 2013 (AU) 2013900100

(51) Int. Cl. F16D 66/02; B60T 17/22

(52) U.S. Cl. CPC F16D 66/023; B60T 17/221

(57) ABSTRACT

A brake sensor and method of use, the brake sensor having a housing and a biased displacement member that extends from the housing into a brake pack assembly. Displacement of the displacement member is measured using a sensor which indicates the amount of wear of brake pads within the brake pack assembly.

### FIELD OF THE INVENTION

The invention relates to a brake wear sensor. In particular, the invention relates, but is not limited, to a brake wear sensor that continuously measures the wear of brake pads, particularly for haul trucks such as the Komatsu 930E ultra class haul truck.

### BACKGROUND TO THE INVENTION

Reference to background art herein is not to be construed as an admission that such art constitutes common general knowledge in Australia or elsewhere.

Traditionally brake wear on certain haul trucks, such as the Komatsu 930E ultra class haul truck, are measured manually at predetermined time intervals. To measure brake wear, a brake measuring tool is manually inserted into a brake check port of a brake pack and the brake travel distance is measured. This is conducted by removing a plug in the brake pack, inserting a portion of the brake measuring tool into the brake pack to contact the brake pads when they are disengaged, noting the distance the tool extends into the brake pack, and then engaging the brakes and taking a second measurement with a ruler. The measured distance of travel of the brake pads between the disengaged and engaged positions can then be used to determine the brake pad wear.

This method of measuring brake wear is time consuming and labour intensive, and provides an undesirable opportunity for personal injury to occur. Furthermore, as the brake pack in such haul trucks is typically oil-cooled, spillage of oil from the brake pack can occur after removing the plug and the brake pack also needs to be bled before use. The method of measurement is also subject to measurement inaccuracies, for example due to human error, and requires the vehicle to be taken out of service for a lengthy period of time while the brake wear is measured. These factors result in significant labour and downtime costs and appreciably reduce the overall operating efficiency of the vehicle.

A further problem is that on some vehicles, notably the Komatsu 930E ultra class haul truck, brake wear can only be measured on the front wheels. This is because the configuration of the rim and tyre assembly on the rear axle limits access to the rear brake pack such that the brake measuring tool cannot be inserted. The rear brake packs are therefore typically assumed to have the same wear characteristics as the front brake pads. This can results in premature replacement of the rear brake pads or, alternatively, overuse of the rear brake pads beyond a point that they should be replaced.

### OBJECT OF THE INVENTION

It is an aim of this invention to provide a brake sensor which overcomes or ameliorates one or more of the disadvantages or problems described above, or which at least provides a useful alternative.

Other preferred objects of the present invention will become apparent from the following description.

### SUMMARY OF INVENTION

According to a first aspect of the invention, there is provided a brake sensor configured to be mounted to a brake assembly, the brake sensor comprising:

a housing;

a displacement member that extends from the housing, the displacement member being movable relative to, and biased away from, the housing; and

a sensor that measures displacement of the displacement member relative to the housing.

The displacement member is preferably elongate with a flanged portion. The flanged portion may be integral with, or mounted to, an elongate plunger portion of the displacement member. Preferably the displacement member is movable relative to the housing along a longitudinal axis. The displacement member is preferably movable approximately 10 to 50 mm relative to the housing, more preferably approximately 20 to 30 mm relative to the housing, and in a preferred form approximately 25 mm relative to the housing.

One end of the displacement member is preferably located within the housing. The end of the displacement member located within the housing preferably has the flanged portion. The flanged portion is preferably a disc. Movement of the displacement member relative to the housing is preferably limited by the disc engaging with stoppers within the housing. At least one stopper preferably comprises an inner surface of the housing. The other stopper may comprise a stopper portion of the sensor located within the housing.

The displacement member is preferably biased in the longitudinal axis. Preferably the displacement member extends variably from the housing with a biasing mechanism that resists insertion of the displacement member into the housing. The displacement member is preferably biased using a spring, more preferably a helical coil spring. The helical coil spring is preferably coiled around an outer surface of at least a portion of the displacement member.

The displacement member preferably has a projection. The projection is preferably located in a middle portion of the displacement member. The projection is preferably a collar that extends circumferentially around the displacement member. The collar may include a seal, preferably a circumferential seal, to fluidly seal the displacement member against a portion of the housing. One end of the helical coil spring preferably engages with the projection of the displacement member. The other end of the helical coil spring preferably engages with a portion of the housing. The projection is preferably received by a portion of the housing. The housing preferably has a restricted portion adjacent a distal end which prevents the projection of the displacement member from leaving the housing.

The sensor is preferably located at least partially within the housing. The sensor preferably measures displacement of at least portion of the displacement member. In a preferred form, the sensor measures displacement of the disc of the displacement member. The sensor is preferably an electronic proximity sensor that measures relative displacement of a target. In a preferred form, the sensor is an inductive sensor that measures proximity to a target metallic portion of the displacement member. Preferably the disc of the displacement member is metallic and the inductive sensor measures the relative distance between the sensor and the disc.

The sensor could be any suitable sensor for measuring displacement of the displacement member, including, for example, a capacitive, reflective, optical, rotary encoder, photoelectric, ultrasonic, laser, magnetic, eddy current, transducer (e.g. linear variable and linear displacement), resistive, potentiometer, pressure, or volume displacement sensor. Alternatively, a microswitch arrangement where movement of the displacement member actuates one or more microswitches could also be used.

The sensor is preferably in communication with an electronic system that receives and processes sensor data from the sensor. An output of the sensor is preferably electrically connected to the electronic system using a cable. Sensor data from the electronic system may be used to monitor and report on brake wear. An alert may be generated, preferably in the form of an audio and/or visual alert, if brake wear is determined to be greater than a predetermined amount. The electronic system may have a data storage system that stores historical sensor data to enable brake wear to be tracked over time and/or distance travelled.

The housing preferably includes a main body portion and a displacement member extension portion. The main body portion and the displacement member extension portion are preferably releasably connectable. Preferably the main body portion and the displacement member extension portion are connectable through an interference fit.

A retaining member may be provided within the housing, preferably to assist with connection of the main body portion and the displacement member. Preferably the retaining member provides an interference fit between at least a portion of the main body portion and at least a portion of the displacement member extension portion. Preferably the retaining member has an aperture that receives the displacement member. Preferably the aperture is centrally located. Preferably the retaining member assists to centre the displacement member within the main body portion and/or the displacement member extension portion.

Preferably the retaining member has a substantially planar portion and a protruding portion. Preferably the aperture extends through the planar portion and the protruding portion. Preferably the protruding portion is at least partially received by the displacement member extension portion of the housing. Preferably the planar portion of the retaining member substantially corresponds in size and shape to the flanged portion of the displacement member. In a preferred form the retaining member is made of metal, preferably bronze.

The main body portion and the displacement member extension portion may have corresponding connectors. Preferably the connectors are corresponding threaded portions. In a form, the main body portion of the housing has an internally threaded female portion and the displacement member extension portion of the housing has an externally threaded male portion.

The main body portion preferably houses the sensor and the target portion of the displacement member. The housing and sensor preferably define a cavity within the housing within which a portion of the displacement member traverses. The displacement member extension portion preferably extends from the main body portion and houses a portion of the displacement member and the spring. The displacement member preferably extends from the displacement member extension portion of the housing. At least the main body portion of the housing is preferably made of a non-metallic material, even more preferably a plastic material. In a preferred form at least the main body portion of the housing is made from Polytetrafluoroethylene (PTFE).

The brake sensor preferably further comprises a cap. The cap preferably mounts to the housing, preferably via a threaded connector. The cap preferably seals an end of the housing, preferably an end of the housing adjacent the sensor output. One or more sealing members, preferably o-rings, may be provided between the cap and the housing. The cap preferably has a hole adjacent the sensor output to allow a cable to be connected to the sensor output with the cap mounted to the housing.

According to a second aspect of the invention, there is provided a method of determining brake pad wear, the method comprising the steps of:

continuously engaging a biased displacement member that extends from a housing mounted in a brake pack assembly with a portion of a brake pad assembly;

taking a first measurement of displacement member displacement when the brake pad is disengaged;

taking a second measurement of displacement member displacement when the brake pad is engaged; and

determining brake pad wear using the first measurement and the second measurement.

Preferably the displacement member engages with brake piston portion of the brake pad assembly. The method preferably uses a brake sensor as described herein.

Further features and advantages of the present invention will become apparent from the following detailed description.

### BRIEF DESCRIPTION OF THE DRAWINGS

By way of example only, preferred embodiments of the invention will be described more fully hereinafter with reference to the accompanying figures, wherein:

FIG. 1 illustrates a perspective view of a brake sensor according to an embodiment of the invention;

FIG. 2 illustrates an exploded perspective view of the brake sensor illustrated in FIG. 1;

FIG. 3 illustrates a cross sectional view of the brake sensor illustrated in FIG. 1 with a brake pad disengaged;

FIG. 4 illustrates a cross sectional view of the brake sensor illustrated in FIG. 3 with the brake pad engaged

FIG. 5 illustrates a perspective view of a brake sensor according to another embodiment of the invention;

FIG. 6 illustrates a cross sectional view of the brake sensor illustrated in FIG. 5; and

FIG. 7 illustrates a flow chart illustrating a method of determining brake pad wear.

### DETAILED DESCRIPTION OF THE DRAWINGS

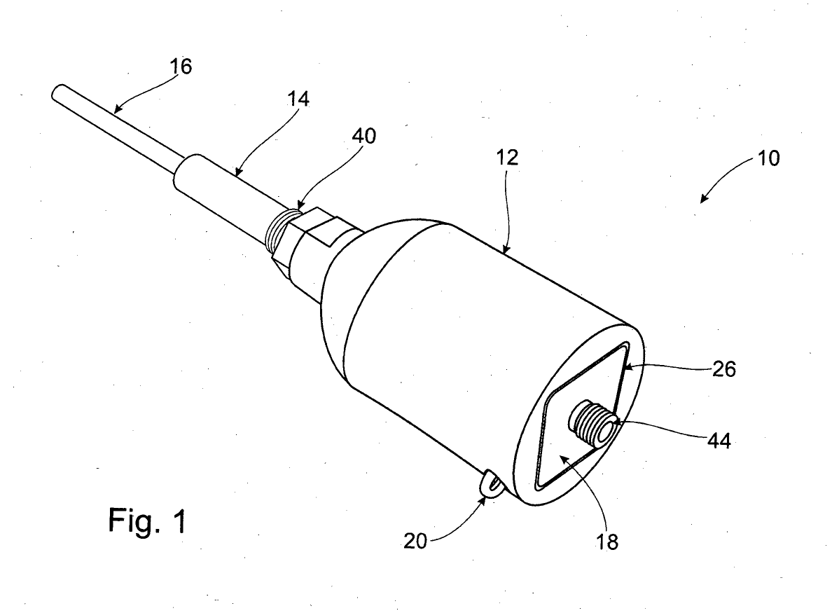

FIG. 1 illustrates a brake sensor 10 according to an embodiment of the invention having a housing comprising a main body portion 12 and a displacement member extension portion in the form of a probe extension portion 14. A displacement member in the form of a probe 16 extends longitudinally from the probe extension portion 14 of the housing. A sensor 18 is located within the main body portion 12 of the housing and retained in place using a retainer in the form of a retaining pin 20.

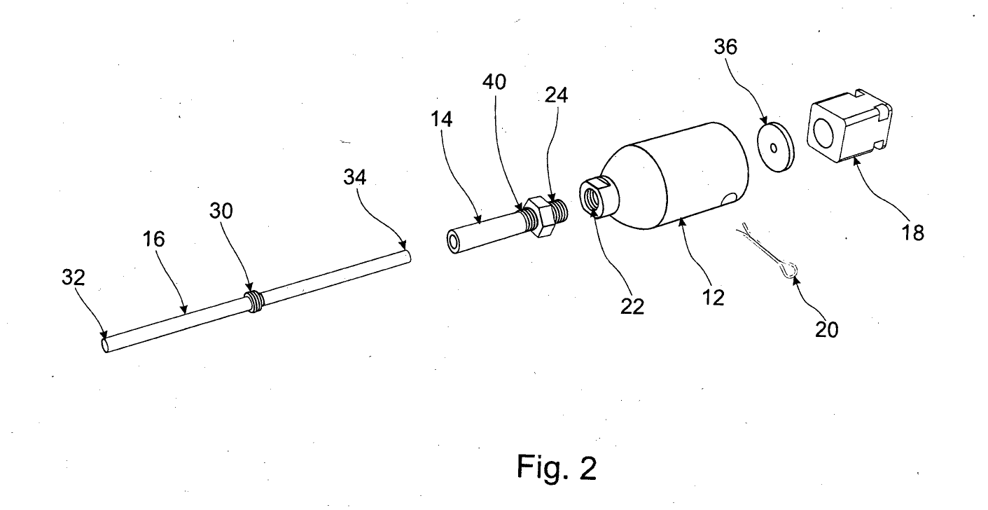

Turning to FIGS. 2 to 4, which illustrate each of the components of the brake sensor 10 in more detail, it can be seen that the main body portion 12 of the housing has a connector in the form of an internally threaded female portion 22 that corresponds to a connector in the form of an externally threaded male portion 24 of the probe extension portion 14 of the housing. As illustrated in FIGS. 1, 3, and 4, the female portion 22 of the main body portion 12 of the housing and the male portion 24 of the probe extension portion 14 of the housing interlock with one another to form a unitary housing.

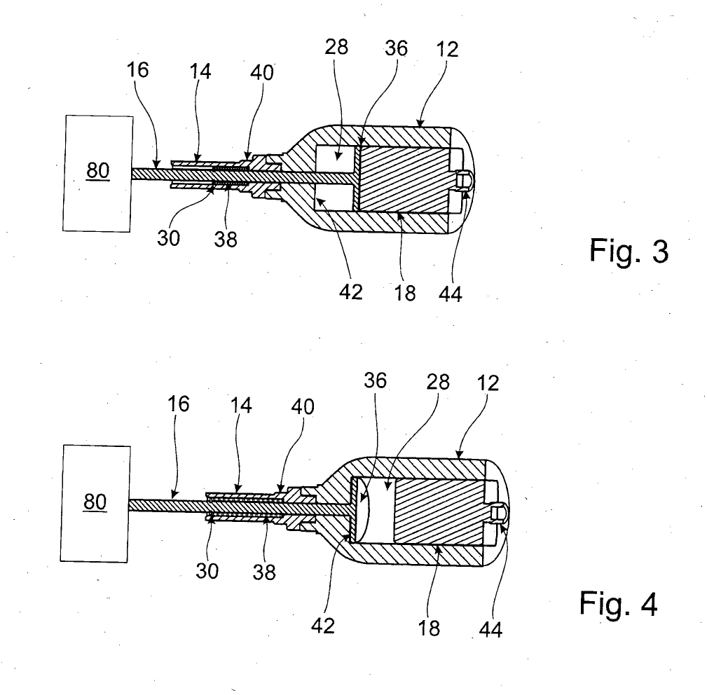

The main body portion 12 of the housing has an internal hollow, seen most clearly in FIGS. 3 and 4, that extends from the female portion 22 to an opening 26 at a rear end thereof. The sensor 18 is located in the opening 26 of the main body portion 12 and, as seen in FIGS. 3 and 4, fits inside the hollow creating a cavity 28. In the illustrated preferred embodiment, the sensor 18 is an inductive sensor directed to sense proximity of a metallic object in the cavity 28 of the main body portion 12 of the housing. In order to prevent sensor interference, at least the main body portion 12 of the housing is made of a non-metallic material which, in a preferred embodiment, is Polytetrafluoroethylene (PTFE).

The probe extension portion 14 also has a hollow, and is generally tubular in form. When connected to the main body portion 12, the hollow of the probe extension portion 14 is in fluid communication with the hollow of the main body portion 12, in particular the hollow of the probe extension portion 14 connects with the cavity 28 of the main body portion 12. The probe 16, as seen most clearly in FIG. 2, is an elongate member with a projection in the form of a collar 30 that extends circumferentially around a middle portion of the probe 26. The probe 16 has a distal end 32 that is distal from the housing and a proximal end 34 that is received by the housing.

The probe 16 and probe extension portion 14 of the brake sensor 10 are typically made of materials suitable for use in a hydraulically cooled brake environment. For example, the materials may be suitable for use up to 200° C. and up to 35 psi. In a preferred embodiment, both the probe 16 and the probe extension portion 14 are made of stainless steel.

When assembled, as shown in FIGS. 1, 3, and 4, the collar 30 of the probe 16 is received within the probe extension portion 14 of the housing and the proximal end 34 of the probe 16 traverses the extension portion 14 extending into the main body portion 12 of the housing. A flanged portion in the form of a circular disc 36 is mounted to the proximal end 34 of the probe 16. The circular disc 36 is made of a metallic material, preferably steel and is located within the cavity 28 of the main body portion 12 of the housing.

As shown in FIGS. 3 and 4, a biasing member in the form of a helical coil spring 38 is provided. The spring 38 is located around an outer surface of the proximal end 34 of the probe 16 and inside the probe extension portion 14. The spring 38 extends longitudinally between the collar 30 of the probe 16 and a portion of the housing, biasing the probe 16 in the longitudinal axis. As illustrated by FIGS. 3 and 4, the helical coil spring 38 compresses in the longitudinal axis, being more compressed in FIG. 3 than in FIG. 4, to bias the probe. In a preferred embodiment the spring 38 is in, or at least near, full compression when the brake pad is disengaged.

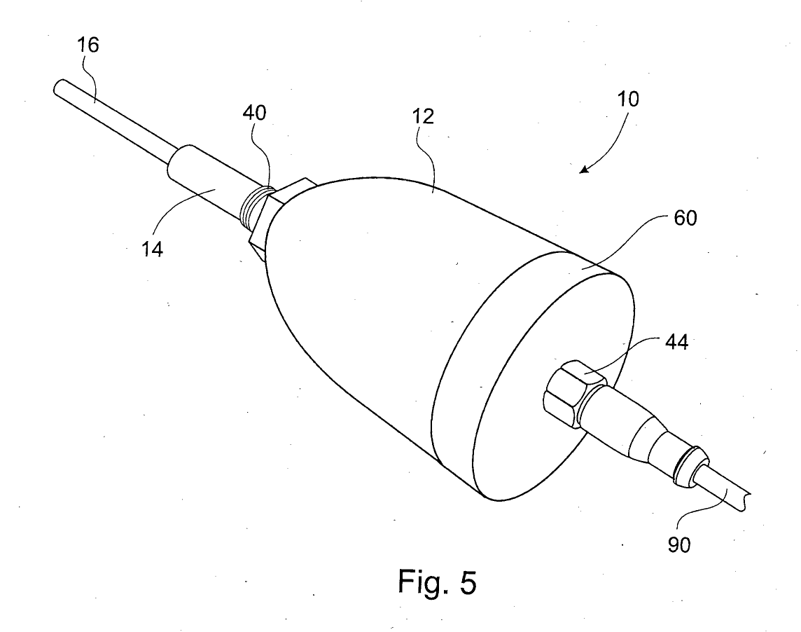

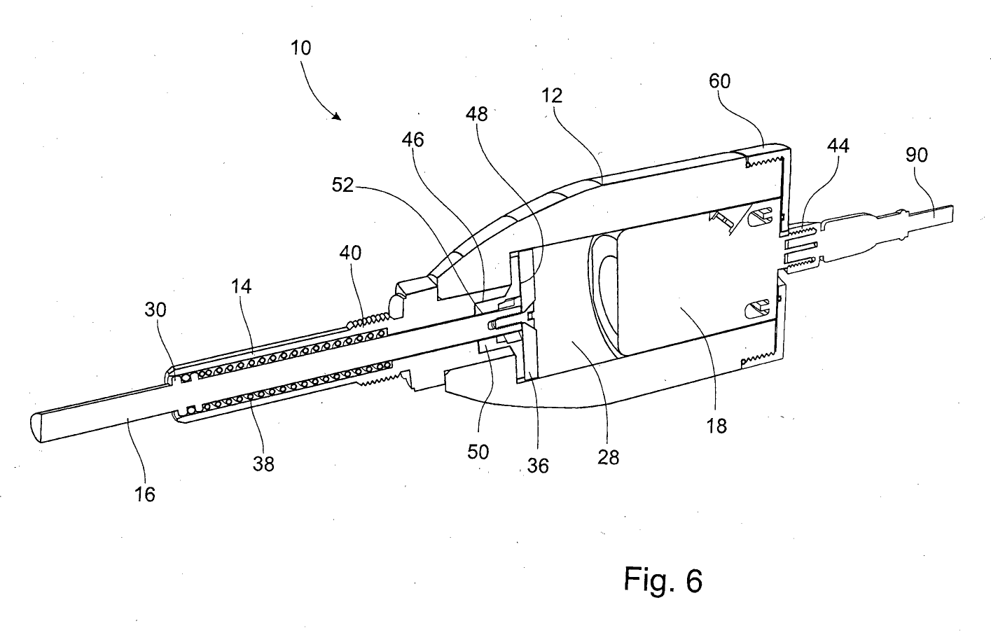

FIGS. 5 and 6 illustrate an alternative embodiment of the brake sensor 10 wherein the probe extension portion 14 of the housing is connected to the main body portion 12 of the housing through an interference fit. A retaining member 46 is provided between the probe extension portion 14 and the main body portion 12 of the housing. The retaining member 46 has a substantially planar base portion 48 and a protruding portion 50 extending therefrom. The protruding portion 50 extends centrally from the substantially planar base portion 48. An axially extending aperture 52 is provided in the retaining member through which the displacement member 16 passes. The retaining member 46 is located between the probe extension portion 14 and the main body portion 12 of the housing in an interference fit and locates the displacement member 16 centrally with respect to the main body portion 12 and probe extension portion 14 of the housing.

The brake sensor 10 illustrated in FIGS. 5 and 6 also has a cap 60 which is mounted to the main body portion 12 of the housing. The cap 60 is threaded onto a corresponding thread of the main body portion 12 of the housing. Sealing members, preferably in the form of o-rings, are typically provided between the cap 60 and the housing 12 to seal an open end of the main body portion 12 of the housing which receives the sensor 18. The cap 60 has a hole through which the 44 to protrudes for connection with a cable 90. The cap 60 not only seals the sensor 18 in the main body portion 12 of the housing, but also retains the sensor 18 therein, such that retaining pin 20 is not required in this embodiment.

In use, brake sensor 10 is mounted in a brake assembly of a vehicle (not shown). In the preferred embodiment, the brake sensor 10 is mounted to a brake check port of an oil-cooled brake pack assembly (not shown) using an externally threaded portion 40 of the probe extension portion 14 of the housing. The probe extension portion 14 of the housing and the probe 16 extend into the oil-cooled brake pack such that the probe 16 engages with a portion of a brake pad assembly, typically a brake piston 80 as illustrated in FIGS. 3 and 4.

The probe 16 is movable relative to the housing 12, 14 of the brake sensor 10 along a longitudinal axis of the probe 16. The spring 38 provides a biasing force longitudinally toward the distal end 32 of the probe 16 keeping the probe 16 extended as far as the brake piston 80 allows. The brake sensor 10 is configured to ensure that the probe 16 can travel the full range of movement of the brake piston 80 along the longitudinal axis of the probe 16, and therefore neither inhibits nor disengages with the brake piston 80, remaining in continuous, or at least substantially continuous, contact with the brake piston 80 during use of the brakes of the vehicle.

For use with an oil cooled brake pack assembly of a haul vehicle such as the Komatsu 930E ultra class haul truck, the probe 16 has a travel range of approximately 25 mm. This range is primarily defined by the distance the circular disc 36 mounted to the proximal end 34 of the probe 16 can travel in the cavity 28 between a stopper portion of the sensor 18 and a stopper portion of the main body portion 12 of the housing in the form of inner surface 42.

As the brakes of the vehicle are engaged and disengaged, brake piston 80 moves along the longitudinal axis of the probe 16. FIG. 3 illustrates the brake piston 80 in a disengaged position and FIG. 4 illustrates the brake piston 80 in an engaged position. As the brake piston 80 moves between the disengaged and engaged positions, the probe 16 of the brake sensor 10, which is held in continuous contact with the brake piston 80 by the spring 38, moves correspondingly.

The circular disc 36 of the probe 16, located inside the main body portion 12 of the housing, therefore moves in the cavity 28 toward and away from the sensor 18. As the circular disc 36 is metallic, and as the sensor 18 is an inductive sensor that measure proximity of metallic objects, the proximity of the circular disc 36 of the probe relative to the sensor 18 is measured.

The sensor 18 produces sensor data, typically an analogue electrical signal in milliamps (mA), transmitted from sensor output 44 which is typically electrically connected to a processor that receives and processes the sensor data. In this regard, the processor receives the analogue electrical signal from the sensor 18 and converts it to a millimetre displacement value. The sensor data can then be utilised to determine wear of the brake pads of the brake assembly.

In a preferred embodiment, the sensor output 44 of the sensor 18 of the brake sensor 10 is connected via cable 90 (see FIGS. 5 and 6) to a monitoring system. The monitoring system can be a standalone unit, typically including a power unit and display, but in a preferred embodiment the brake sensor 10 is connected and integrated into a monitoring system of the vehicle.

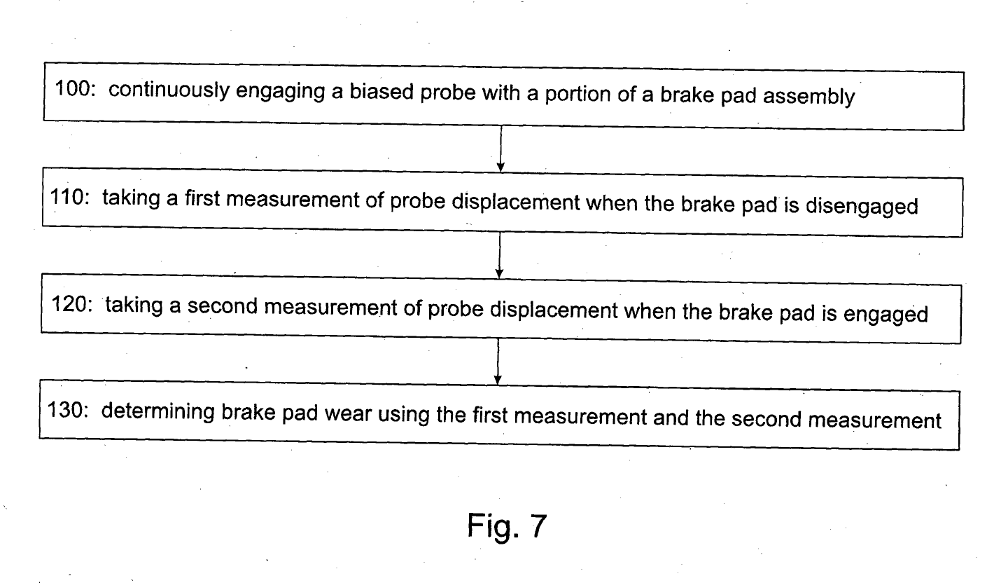

FIG. 7 illustrates a flowchart for a method of determining brake pad wear. The biased probe 16 that extends from the housing 12, 14 mounted in the brake pack assembly is, as described above, in continuous engagement with a portion of a brake pad assembly (step 100). A first measurement of probe displacement is taken when the brake pad is disengaged (step 110) and a second measurement of probe displacement is taken when the brake pad is engaged (120).

Whether the brake pads are engaged or disengaged may be determined by considering the displacement of the probe 16, particularly taking into account historical data and how long the probe is located at particular displacements. A processor in communication with the brake sensor 10 may be utilised to automatically determine when the brake pad is disengaged and engaged. Alternatively, or optionally to calibrate an automatic system, an operator may manually determine when the brakes are engaged or disengaged.

Once the two measurements have been taken, the brake pad wear is then determined (step 130). Brake pad wear may be determined by considering the distance of travel of the probe 16 compared to a predetermined known value for non-worn brake pads or from a known travel distance from the disengaged position. If the probe 16 travels further than it would with non-worn brake pads, the difference is measured and attributed to brake pad wear. Brake pad wear data can then be used to analyse brake wear which provides many benefits.

Advantageously, the brake sensor 10 allows brake pad wear to be measured easily by an operator without having to take the vehicle out of service and measure the wear manually. This significantly reduces the time needed to measure the brake pad wear which in turn reduces the downtime of the vehicle. Furthermore, measurements can be taken with practically no health and safety risk.

Brake pad wear measurements can therefore be taken at much shorter time intervals, or even substantially continuously. Wear analysis data can be used to accurately determine when the brake pads are likely to need replacing allowing better planning and preparation for brake servicing. Notifications can also be provided if brake wear is considered to be, or approaching, a critical level.

Useful brake life may be extended by monitoring actual brake wear and ensuring brakes aren't replaced prematurely, such as when conducting routine maintenance. Furthermore, actual brake life can also be extended by monitoring brake wear and determining when heavy wear occurs. Improvements may then be able to made, such as altering driving habits, to reduce the periods of heavy wear.

The brake sensor 10 is also compact and can be mounted where traditional manual reading could not occur, such as in a rear brake pack of a Komatsu 930E vehicle. This allows both the front and rear brake wear to be monitored independently.

In a fairly typical working environment, the brake assemblies of a Komatsu 930E vehicle are replaced every 24,000 hours at significant expense. It is envisaged that the present invention will allow the brake assemblies to be operational for 30,000 hours, significantly reducing downtime and operational costs.

In this specification, adjectives such as first and second, left and right, top and bottom, and the like may be used solely to distinguish one element or action from another element or action without necessarily requiring or implying any actual such relationship or order. Where the context permits, reference to an integer or a component or step (or the like) is not to be interpreted as being limited to only one of that integer, component, or step, but rather could be one or more of that integer, component, or step etc.

The above description of various embodiments of the present invention is provided for purposes of description to one of ordinary skill in the related art. It is not intended to be exhaustive or to limit the invention to a single disclosed embodiment. As mentioned above, numerous alternatives and variations to the present invention will be apparent to those skilled in the art of the above teaching. Accordingly, while some alternative embodiments have been discussed specifically, other embodiments will be apparent or relatively easily developed by those of ordinary skill in the art. The invention is intended to embrace all alternatives, modifications, and variations of the present invention that have been discussed herein, and other embodiments that fall within the spirit and scope of the above described invention.

In this specification, the terms ‘comprises’, ‘comprising’, ‘includes’, ‘including’, or similar terms are intended to mean a non-exclusive inclusion, such that a method, system or apparatus that comprises a list of elements does not include those elements solely, but may well include other elements not listed.

1. A brake sensor configured to be mounted to a brake assembly, the brake sensor comprising:
a housing;
a displacement member that extends from the housing, the displacement member being movable relative to, and biased away from, the housing; and
a sensor that measures displacement of the displacement member relative to the housing.

2. The brake sensor of claim 1, wherein the displacement member is elongate with a flanged portion.

3. The brake sensor of claim 2, wherein the flanged portion is a disc.

4. The brake sensor of claim 1, wherein the displacement member is movable relative to the housing along a longitudinal axis.

5. The brake sensor of claim 4, wherein the displacement member is movable approximately 10 to 50 mm relative to the housing.

6. The brake sensor of claim 1, wherein one end of the displacement member is located within the housing.

7. The brake sensor of claim 1, wherein the displacement member extends variably from the housing with a biasing mechanism that resists insertion of the displacement member into the housing.

8. The brake sensor of claim 1, wherein the displacement member is biased using a spring.

9. The brake sensor of claim 8, wherein the spring is a helical coil spring coiled around an outer surface of at least a portion of the displacement member.

10. The brake sensor of claim 1, wherein the displacement member has a projection located in a middle portion of the displacement member.

11. The brake sensor of claim 10, wherein the projection is a collar that extends circumferentially around the displacement member.

12. The brake sensor of claim 11, wherein the collar includes a seal to fluidly seal the displacement member against a portion of the housing.

13. The brake sensor of claim 10, wherein the housing has a restricted portion adjacent a distal end which prevents the projection of the displacement member from leaving the housing.

14. The brake sensor of claim 1, wherein the sensor is an electronic proximity sensor that measures relative displacement of a target.

15. The brake sensor of claim 14, wherein the sensor is an inductive sensor that measures proximity to a target metallic portion of the displacement member.

16. The brake sensor of claim 1, wherein the sensor is in communication with an electronic system that receives and processes sensor data from the sensor to monitor and report on brake wear.

17. The brake sensor of claim 1, wherein the housing includes a main body portion and a displacement member extension portion, wherein the main body portion and the displacement member extension portion are releasably connectable.

18. The brake sensor of claim 1 further comprising a retaining member located within the housing.

19. The brake sensor of claim 18, wherein the retaining member has a centrally located aperture that receives the displacement member.

20. The brake sensor of claim 1, wherein the housing and the sensor define a cavity within the housing within which a portion of the displacement member traverses.

21. The brake sensor of claim 1 further comprising a cap that mounts to the housing.

22. The brake sensor of claim 21, wherein one or more sealing members are provided between the cap and the housing.

23. A method of determining brake pad wear, the method comprising the steps of:
continuously engaging a biased displacement member that extends from a housing mounted in a brake pack assembly with a portion of a brake pad assembly by biasing the displacement member away from the housing;
taking a first measurement of displacement member displacement when the brake pad is disengaged;
taking a second measurement of displacement member displacement when the brake pad is engaged; and
determining brake pad wear using the first measurement and the second measurement.

24. The method of claim 23, wherein the displacement member engages with a brake piston portion of the brake pad assembly.

25. The method of claim 23, wherein the method uses a brake sensor as claimed in claim 1.
